(19) United States
(12) Patent Application Publication
(10) Pub. No.: US 2021/0059114 A1
(43) Pub. Date: Mar. 4, 2021

(54) Apparatus, Systems And Methods For Stalk Sensing

(71) Applicant: Ag Leader Technology, Ames, IA (US)

(72) Inventors: Scott Eichhorn, Ames, IA (US); Alan F. Barry, Nevada, IA (US); Tony Woodcock, Ames, IA (US); Roger Zielke, Huxley, IA (US)

(21) Appl. No.: 17/013,037

(22) Filed: Sep. 4, 2020

Related U.S. Application Data
(60) Provisional application No. 62/895,676, filed on Sep. 4, 2019.

(51) Int. Cl. A01D 34/00; A01B 79/00

(52) U.S. Cl. CPC A01D 34/006; A01D 45/02; A01B 79/005

(57) ABSTRACT

The disclosed apparatus, systems and methods relate to a physical stalk sensing system comprising at least one resilient member. Sensors having the resilient member or members are able to estimate the size of the stalks of row crops as they pass through a field, such as a corn field. The sensors can be mounted on a corn head and the results can be analyzed and visualized.

### CROSS-REFERENCE TO RELATED APPLICATION(S)

This application claims priority under 35 U.S.C. § 119(e) and/or § 120 to U.S. Application 62/895,676, filed Sep. 4, 2019 and entitled “Apparatus, Systems And Methods for Stalk Sensing,” which is hereby incorporated herein by reference in their entirety for all purposes.

### TECHNICAL FIELD

This disclosure relates generally to agricultural implements, more particularly agricultural implements and sensors for detecting, measuring and displaying information about plant stalks during harvest.

### BACKGROUND

The prior art discloses using moveable stripper (deck) plates to measure the diameter of stalks moving between the plates. This has the disadvantage of multiple stalks being present between the plates simultaneously. This, in turn, may prevent detection or measurement of smaller stalks while larger stalks are also present between the plates. Other prior art discloses a method to measure a single stalk passing between members disposed to move laterally or rotationally when a stalk passes by. The drawback of this method arises when a stalk 4 passes along the extreme edges of the measurement fixture, contacting only one of the sensing members 4 and making a correct diameter (d) measurement impossible, shown for example in FIG. 1.

The prior art also teaches a sensing method comprising overlapping, rotating, sensing members 4 that contact the stalk 2 as it passes by, shown for example in FIG. 2. This method reduces the diameter (d) measurement errors present in the horizontally moveable sensing method for single stalk measurement discussed above. Yet, these methods are subject to sensor tip wear over time.

These known methods have an issue with physical wear of the sensing members 4. Over 5 million corn stalks could be reasonably expected to pass through each sensing mechanism each season. An example of this physical wear including sensor tip wear is shown in FIG. 3. These worn sensing members 4 will no longer accurately measure stalk diameter (d).

Additionally, another disadvantage of the prior art is that with 5 million cycles anticipated each season noticeable wear is expected on any dynamic seal. Additionally, there is significant dust generated during the harvest operation that can accelerate wear of any dynamic seal or bearing.

Further, normal field operations may also be expected to cause periodic plugging or jamming of the corn head with plant material or soil, potentially causing permanent misalignment of the sensing members 4. Corn head gathering chains may be operated in reverse to expel stalks and other debris that may periodically jam in the stalk rollers and gathering chains. The prior art methods do not teach any method to that would prevent damage to the sensing members 4 when stalks 2 or debris must pass through the corn head in the opposite direction.

Finally, while the sensing members 4 need an adequate force to return them to a neutral position quickly enough to distinguish between individual stalks 2 passing by, the rigid nature of these known sensing members 4 can easily rebound off of a target and cause measurement oscillations that make distinguishing individual stalks 2 difficult.

There is a need in the art for devices, systems, and methods for sensing corn stalks and various parameters thereof during harvest.

### BRIEF SUMMARY

Disclosed are stalk sensing devices, systems, and methods that address the various shortcomings noted above. In various implementations, the flexible, resilient sensing member(s) or wand(s) eliminates the need for any kind of dynamic seal. The disclosed implementations may also eliminate any gap between the sensing members when a stalk is not present. Further, in some implementations, sensing member(s) are kept in contact by the force of the resilient member(s) themselves.

Disclosed herein are various harvesters, more specifically corn heads and associated sensors and data visualization systems for use in conjunction with combine harvesters. Various sensors mounted on a corn head may count and measure corn stalks as they pass through the corn head during harvest. Various processing components and display units may be used to calculate and display information about the measured stalks to provide the user with information about yield including on a row-by-row and plant-by-plant level, as would be appreciated.

In Example 1, a stalk measuring system comprising a row unit, at least one resilient sensing member engaged with the row unit, a distance sensor within a housing on the row unit, and a sensor target on the at least one resilient sensing member, wherein the distance sensor is constructed and arrange to measure the deflection of the sensor target as the resilient sensing member flexes in response to harvest operations.

In Example 2, the system of claim 1, wherein the amount of deflection corresponds to stalk perimeter.

In Example 3, the system of claim 1, wherein deflection corresponds to a stalk count.

In Example 4, the system of claim 1, wherein the at least one resilient sensing member is comprised of at least one of elastic, viscoelastic, nitrile, ethylene propylene diene terpolymer (EPCM), neoprene, natural rubber, silicone, fluro-elastomer, and spring steel.

In Example 5, the system of claim 1, wherein the at least one resilient member is comprised of a composite material, wherein the composite material comprises at least one of cellulose, aramid, nylon, glass, and carbon fiber.

In Example 6, the system of claim 1, wherein the at least one resilient member further comprises a contact surface and an additional material disposed on the contact surface.

In Example 7, the system of claim 6, wherein the additional material is at least one of acetal, resin, nylon resin, thermoplastic polyester elastomer, liquid crystal polymer resin, and metal.

In Example 8, a stalk sensor comprising a first wand operationally engaged with a first side of a row unit at an attachment point, a first distance sensor disposed on the row unit in proximity to the first wand, and a first sensor target embedded within the first wand, wherein the stalk sensor is constructed and arranged to measure the deflection of the first wand in response to passage of a stalk through the stalk sensor, and wherein the amount of deflection corresponds to the perimeter of the stalk.

In Example 9, the stalk sensor of claim 8, wherein the first sensor target is a magnet.

In Example 10, the stalk sensor of claim 9, wherein the first distance sensor is a magnetic field sensor.

In Example 11, the stalk sensor of claim 8, further comprising a second distance sensor disposed on the row unit and a second sensor target embedded within the second wand.

In Example 12, the stalk sensor of claim 8, further comprising a second wand operationally engaged with a second side of the row unit, a second distance sensor disposed on the row unit in proximity to the second wand, and a second sensor target disposed within the second wand, wherein the stalk sensor is constructed and arranged to measure the amount of deflection of the first wand and the second wand in response to passage of a stalk through the stalk sensor, and wherein the cumulative amount of deflection of the first wand and the second wand corresponds to the perimeter of the stalk.

In Example 13, the stalk sensor of claim 12, wherein the first distance sensor and second distance sensor are magnetic field sensors and the first sensor target and second sensor target are magnets.

In Example 14, the stalk sensor of claim 13, wherein the first wand and second wand are arranged to span across an entirely of a stripper plate gap of the row unit.

In Example 15, a stalk sensing system comprising a row unit, a first wand comprising a first magnet, the first wand disposed a first side of the row unit, and a second wand comprising a second magnet, the second wand disposed on a second side of the row unit, a first magnetic field sensor disposed on the first side of the row unit, the first magnetic field sensor constructed and arranged to measure a deflection distance of the first wand, a second magnetic field sensor disposed on the second side of the row unit, the second magnetic field sensor constructed and arranged to measure a deflection distance of the second wand, wherein the sum of the deflection distance of the first wand and the deflection distance of the second wand correspond to a stalk perimeter.

In Example 16, the system of claim 15, wherein the first wand and the second wand are arranged to be substantially opposite each other on the row unit and located on the same horizontal plane.

In Example 17, the system of claim 15, wherein the first wand and the second wand are arranged to be substantially opposite each other on the row unit and located on the different horizontal planes.

In Example 18, the system of claim 15, wherein the first wand and the second wand are arranged in sequence on the row unit.

In Example 19, the system of claim 15, wherein the first wand and the second wand are arranged such that a first end of the first wand overlaps with a first end of a second wand at the center of the row unit.

In Example 20, the system of claim 15, wherein the first wand and the second wand are mounted below a set of stripper plates on the row unit.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 shows a prior art implementation of a stalk sensor.

FIG. 2 shows another prior art implementation of stalk sensor.

FIG. 3 shows sensor tip wear of a prior art stalk sensor.

FIG. 4 is a top view of a harvester and corn head, according to one implementation.

FIG. 5 is a top view of a single wand sensor, according to one implementation.

FIG. 6A is a top view of a single wand sensor with varying thickness, according to one implementation.

FIG. 6B shows the single wand sensor of FIG. 6A with a stalk passing through the sensor, according to one implementation.

FIG. 7A is a top view of a single wand sensor with additional material along the length of the wand, according to one implementation.

FIG. 7B is a top view of a single wand sensor with additional material at the lip of the wand, according to one implementation.

FIG. 8 is a top view of a single wand sensor having both rigid and resilient portions, according to one implementation.

FIG. 9A is a top view of a single wand sensor having two attachment points, according to one implementation.

FIG. 9B shows the single wand sensor of FIG. 9A with a stalk passing through the sensor, according to one implementation.

FIG. 10A is a top view of a single wand sensor with a sliding joint, according to one implementation.

FIG. 10B shows the single wand sensor of FIG. 10A with a stalk passing through the sensor, according to one implementation.

FIG. 11A a top view of a single wand sensor having a convoluted section, according to one implementation.

FIG. 11B shows the single wand sensor of FIG. 11A with a stalk passing through the sensor, according to one implementation.

FIG. 12A is a top view of a dual wand sensor where each wand has two attachment points and both rigid and resilient section, according to one implementation.

FIG. 12B shows the dual wand sensor of FIG. 12A with a stalk passing through the sensor, according to one implementation.

FIG. 13 is a top view a row unit with a guide, according to one implementation.

FIG. 14 is a top perspective view of a single wand sensor installed on a row unit, according to one implementation.

FIG. 15 is a close up view of a stalk passing through the single wand sensor of FIG. 14, according to one implementation.

FIG. 16 is a top perspective view of a dual wand sensor installed on a row unit, according to one implementation.

FIG. 17 is a front view of a stalk passing through a dual wand sensor, according to one implementation.

FIG. 18 is a top view of a single wand sensor, according to one implementation.

FIG. 19 is a top view of a stalk passing through a single wand sensor, according to one implementation.

FIG. 20 is a top view of a single wand sensor, according to one implementation.

FIG. 21 is a top view of a misaligned stalk passing through a single wand sensor, according to one implementation.

FIG. 22 is a top view of a dual wand sensor, according to one implementation.

FIG. 23 is a top view of a stalk passing through a dual wand sensor, according to one implementation.

FIG. 24 is a top view of a dual wand sensor where the wands are arranged to be vertically stacked, according to one implementation.

FIG. 25 is a top view of dual wand sensor where the wand are arranged in sequence, according to one implementation.

FIG. 26 is a top view of single wand sensor have multiple sensors and sensor targets, according to one implementation.

FIG. 27 show the X, Y, and Z axes of a magnet, according to one implementation.

FIG. 28 is a top view of a single wand sensor having a load cell, according to one implementation.

FIG. 29 shows a graph of detected magnetic field strength over time, according to one implementation.

FIG. 30 shows a graph of detected magnetic field strength over time, according to one implementation.

FIG. 31 shows a graph of wand displacement calculated from the detected magnetic field strength over time, according to one implementation.

FIG. 32A shows a stalk passing through a dual wand sensor in the reverse direction, according to one implementation.

FIG. 32B shows a stalk passing through a dual wand sensor in the reverse direction, according to one implementation.

FIG. 33A shows a stalk passing through a dual wand sensor in the reverse direction, according to one implementation.

FIG. 33B shows a stalk passing through a dual wand sensor in the reverse direction, according to one implementation.

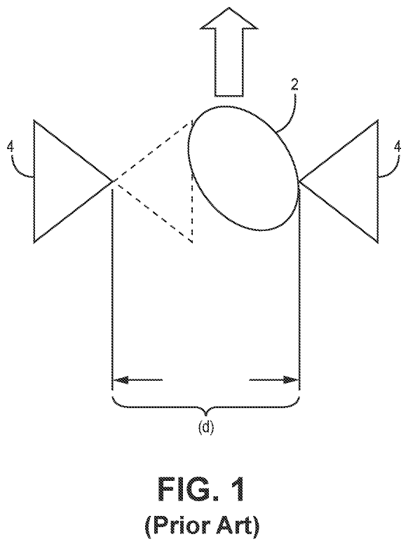

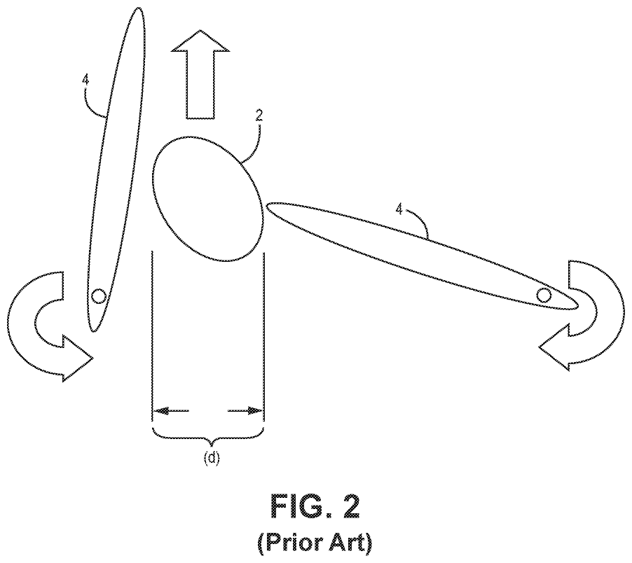

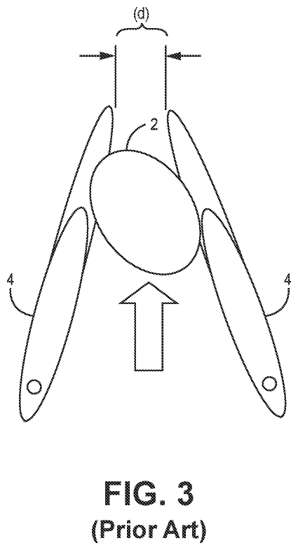

### DETAILED DESCRIPTION

The various implementations disclosed or contemplated herein relate to various devices, systems and methods for the sensing of plants as they pass through a sensing system. That is, the various implementations include one or more sensing members mounted to a harvester row unit to engage with stalks as the enter the row unit. The various sensing members are used in conjunction with various processing components to measure stalk perimeter, count stalks, detect missing and late emerged plants, and estimate yield, among other functions that would be appreciated by those of skill in the art.

It would be understood the various sensor systems can be used with various agricultural systems including guidance, navigation, mapping, and yield monitoring systems. The various sensor systems disclosed herein can be incorporated into, used in conjunction with, or used as part of any other known agricultural system. For example, the various implementations disclosed herein may be incorporated into or used with any of the agricultural system disclosed in U.S. patent application Ser. No. 16/445,161 (filed Jun. 18, 2019 and entitled “Agricultural Systems Having Stalk Sensors and/or Data Visualization Systems and Related Devices and Methods”) and U.S. patent application Ser. No. 16/800,469 (filed Feb. 28, 2020 and entitled “Vision Based Stalk Sensors and Associated Systems and Methods”), all of which are hereby incorporated by reference in their entireties.

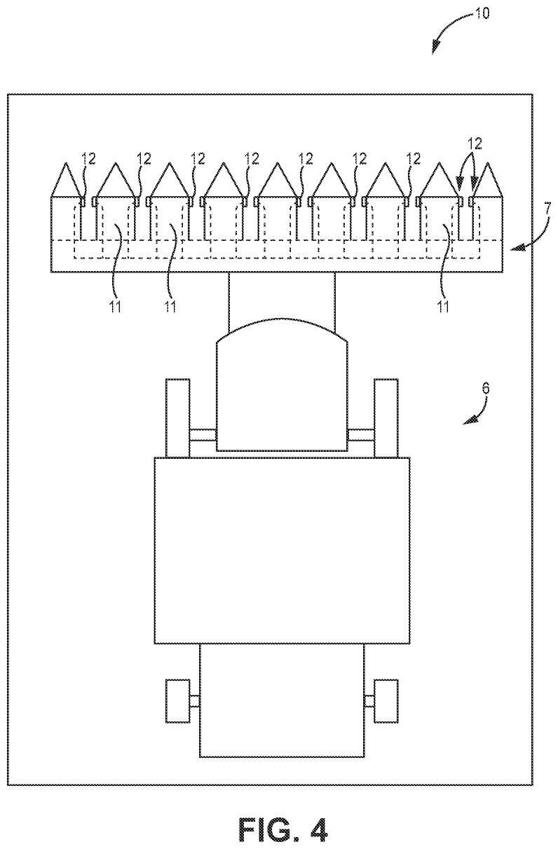

FIG. 4 shows a schematic drawing of a stalk sensing system 10. In various implementations, the stalk sensing system 10 is used in conjunction with a harvester 6, such as a combine 6, with a corn head 7. As would be appreciated, in various implementations, a corn head 7 is made up of a plurality of row units 11. Typically, each row unit 11 is substantially identical on a single corn head 7, however, certain variations in configuration are possible and readily understood. In certain implementations, each row unit 11 includes one or more sensing member 12.

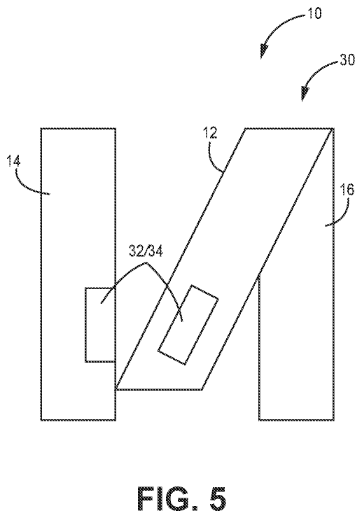

FIGS. 5-27 show various implementations of a stalk sensing system 10 having resilient sensing members 12 utilized for detecting, evaluating and counting the presence of row crop stalks. These various implementations of the stalk sensing system 10 can be used to establish various characteristics about the row crop such as the number of plants, the size of the plants and other factors, and can be used by the operator in various useful estimates in combination with other technologies, such as processing and visualization technologies, as is described in detail herein.

I. Resilient Member Stalk Diameter Measurement

The advantages of using one or more resilient member(s) 12 include improved wear performance over designs using bearing or dynamic seals, member 12 flexibility that allows stalks 2 moving in the opposite direction to pass by without causing damage, significant reduction in signal oscillation due to member 12 rebound, and resistance to damage from foreign objects entering the corn head 7. Further advantages will be apparent to those of skill in the art from the present disclosure.

In various of these implementations of the stalk sensing system 10, the resilient member 12 is connected to a member attachment 16 in connection with a row unit 11. Further, in certain implementations, the system 10 includes a fence 14 disposed on the row unit 11 opposite of the member attachment 16 that is constructed and arranged to act as a stop for the wand(s) 12 and optionally a guide for various stalks 2 as they enter the row unit 11. It is appreciated that the wand(s) 12 are then able to return to starting position(s) prior to a subsequent stalk 2 entering the corn head 7, as described herein.

FIG. 5 depicts one such implementation of a stalk sensing system 10 having one or more wands 12 of resilient, elastic material (also referred to as resilient members). The wands 12 are constructed and arranged to be deflected by passing stalks 2 during harvest operations. In some implementations, the stalk sensing system 10 is a single member sensor 30 or a dual member sensor 40. In these implementations, the various wands 12 may contain sensors 32 or sensor targets 34 that allow the deflection of the wands 12 to be measured. In various implementations, the sensors 32 may be electromagnetic sensors, non-contact inductive position sensors, inductance sensors, capacitive sensors, optical sensors, flexible resistance sensors, load cells, ultrasonic distance sensors, or other sensor type as would be appreciated by those of skill in the art.

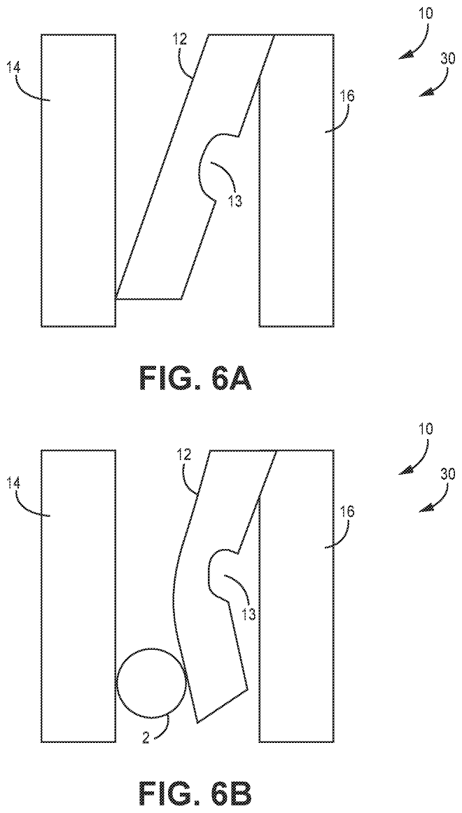

In certain implementations, the resilient member wand 12 may include a portion that is thinner than the surrounding material, causing the wand 12 to preferentially bend or flex preferentially in this tapered portion 13 when the stalks 2 pass through the sensor 30, as shown in FIGS. 6A and 6B. Further implementations are of course possible. This

In certain implementations, the resilient member wands 12 are made of polyurethane rubber, but could also be constructed of other elastic, viscoelastic, or even metal materials. Examples include, but are not limited to, nitrile, ethylene propylene diene terpolymer (EPDM), neoprene, natural rubber, silicone, fluro-elastomer, and spring steel. Further elastic or viscoelastic materials are of course contemplated.

In various additional implementations, the resilient member(s) 12 may be composite, that is, they may comprise several materials including those that alter the physical properties of the resulting composite material, as would be familiar to those skilled in the art. Examples include, but are not limited to, inclusion of cellulose, aramid, nylon, glass, or carbon fibers. That is, in certain implementations of the system 10 disclosed herein, the member 12 or members 12 comprise more than one of the disclosed materials or material types as a composite, alloy, polymer or the like.

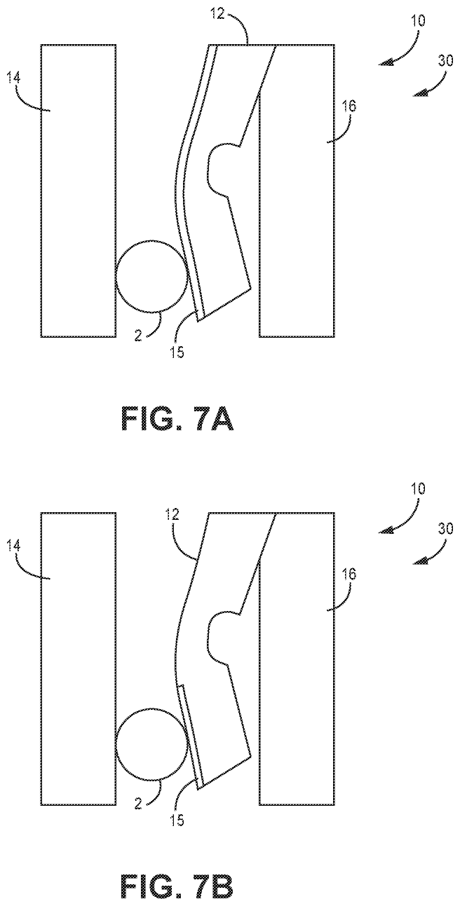

As would be understood, corn leaves and stalks 2 are mildly abrasive and therefore could cause wear over time on resilient members 12 made from certain materials that would otherwise be suited to this type of use. In various of these instances an optional additional material 15 could be added to the resilient member 12. In some implementations, the additional material 15 may extend along the entire length of the contact portion of the resilient member 12, as shown in FIG. 7A. In various alternative implementations, the additional material 15 may be present only on the tip/distal end of the contact side of the resilient member 12, as shown in FIG. 7B. This additional material 15 may exhibit a range of flexibilities such as to be similar to the resilient member 12 or in various other implementations the additional material 15 may be very rigid. Examples for this additional material 15 include, but are not limited to, acetal resin, nylon resin, thermoplastic polyester elastomer, liquid crystal polymer resin, or a wide range of metals.

The geometry and stiffness of the resilient member(s) 12 and their material composition are designed to provide an adequate, but not excessive, restoring force to the neutral position. Insufficient restoring force may result in a sluggish return of the resilient member or members to their neutral position. But, excessive restoring force may increase the likelihood of the resilient member 12 or members 12 not flexing in response to an incoming stalk 2 but instead pushing over the incoming stalks 2 and/or causing stalks 2 to bunch and potentially plug the corn head 7. That is, proper restoring force will not impede crop flow, yet is still capable of detecting closely spaced corn stalks 2, as would be readily appreciated. Accordingly, in certain implementations the resilient member(s) 12 are configured to have between about 1 to about 4 pounds of restoring force urging them back into the neutral position. It is appreciated that certain implementations have a total of about 2 pounds of restoring force applied by the resilient member(s) 12.

In one example, stalks 2 may be spaced about one (1) inch apart and a harvester traveling at six miles per hour; in this example the system 10 has about 0.01 seconds to differentiate between stalks 2. While the resilient member or members 12 do not need to return to the fully neutral position in this time, the member(s) 12 must return far enough to distinguish each individual stalk 2. If the resilient member 12 were not to return to a neutral position or substantially so, the two stalks 2 may appear the same as a corn ear, a mass of vegetation, or other anomaly.

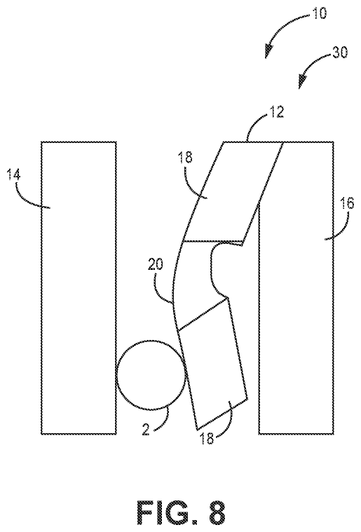

In another implementation, the resilient member 12 or members 12 comprise a combination of rigid portions 18 and elastic, resilient portions 20. In various implementations, more rigid portions 18 are located where the member contacts the corn stalk 2 and the elastic, resilient portions 20 are located where flexibility is desired to allow the member(s) 12 to deflect, shown for example in FIG. 8. Of course alternative configuration are possible, as would be appreciated.

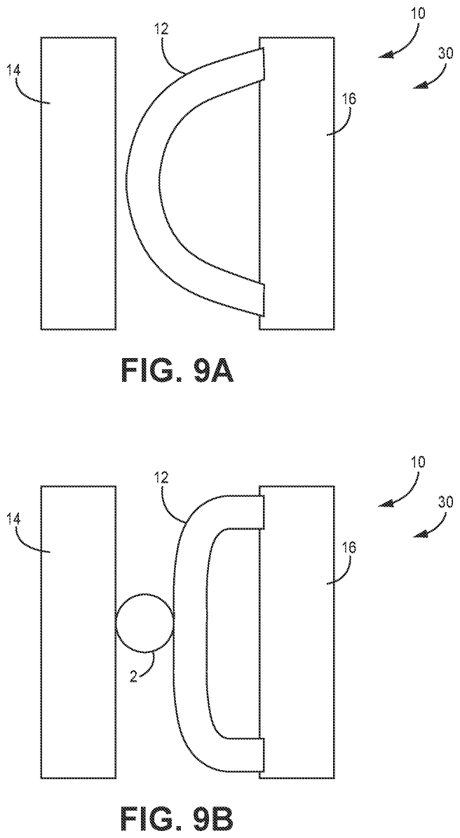

Implementations of sensing system 10 include various geometries and configurations of one or more resilient members 12, fences 14, and member attachments 16. In various implementations, a resilient member 12 or members 12 have one connection to the member attachment(s) 16, as shown for example in FIGS. 4-7. In various alternative implementations, the resilient member 12 or members 12 have two connections to the member attachment(s) 16, shown for example in FIGS. 9A and 9B.

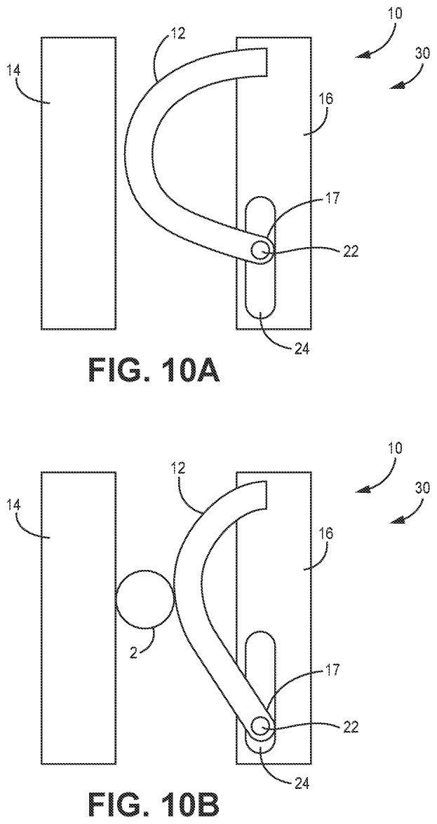

In certain implementations, the resilient member 12 or members 12 have one fixed connection to the member attachment(s) 16 and one sliding joint attachment 17, shown for example in FIGS. 10A and 10B. In these implementations, the resilient member 12 or members 12 are fixedly attached at one end to the member attachment 16 and are slidingly attached to the member attachment 16 at a second end via a sliding joint 22 or pin 22. The sliding joint 22 is then constructed and arranged to slide within a slot 24 within the member attachment 16 in response to a stalk 2 passing through the sensing system 10.

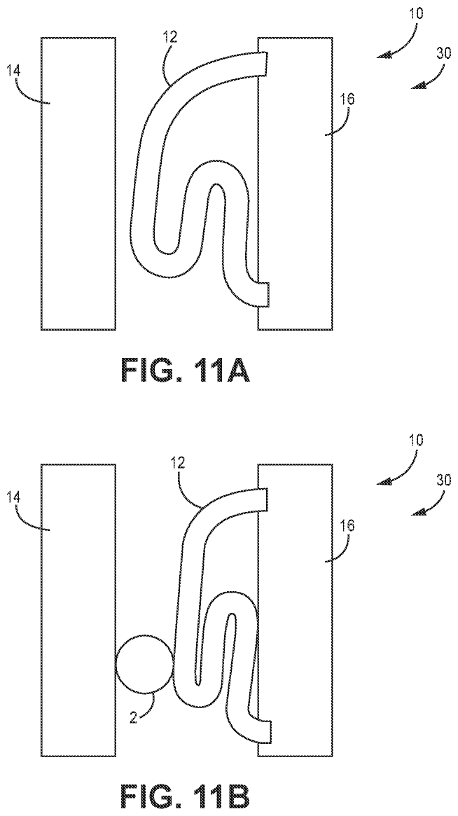

In another alternative implementation, shown in FIGS. 11A and 11B, the resilient member 12 has two fixed connections to the member attachment 16 and includes a thinner or convoluted section that causes the member 12 to preferentially buckle at that location when a stalk 2 passes by the resilient member 12.

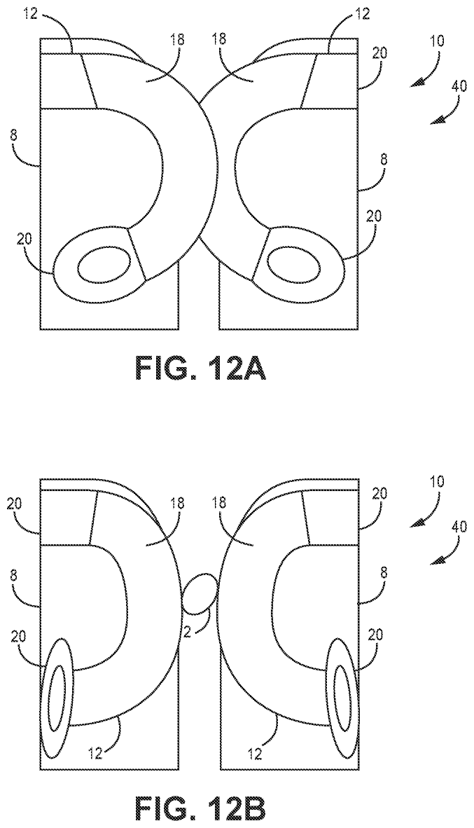

In still further implementations, as shown for example in FIGS. 12A and 12B, the sensing system 10 includes two resilient members 12—a dual wand system 40. In these and other implementations, the resilient members 12 include both rigid portions 18 and flexible portions 20. In certain alternative implementations, the resilient members 12 include a rigid portion 18 along the central portion of the member 12 and are attached to the deck plate 8 or member attachment 16 via resilient/elastic portions 20. Alternative configurations are of course possible.

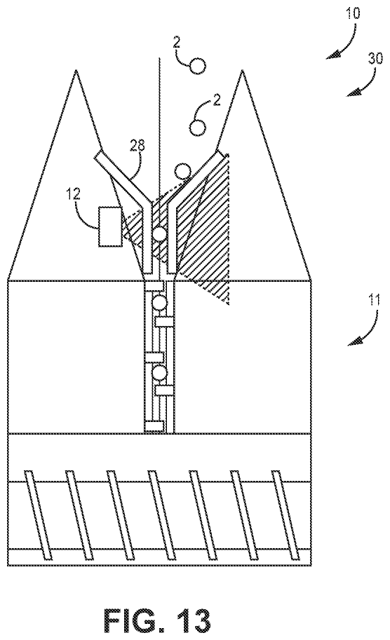

Turning to FIG. 13, poorly centered or angled stalks 2 may cause measurement errors during harvest operations. In various implementations, the system 10 may employ a mechanism 28, such as a guide 28 or shield 28, that constrains the stalks 2 to a centered and/or more vertical position during measurement. These guides 28, shields, and other related methods and devices have been disclosed as part of U.S. Provisional Application 62/810,231, filed Feb. 25, 2019, and U.S. patent application Ser. No. 16/800,469, filed Feb. 28, 2020, which are incorporated by reference herein. In various of these previously disclosed implementations, a system includes a camera as a sensing member in place of the resilient member(s) 12 disclosed herein. In light of this disclosure those of skill in the art would recognize and be able to substitute the resilient member(s) 12 disclosed herein in place of the previously disclosed camera and vision type systems. In various of these implementations, the resilient member(s) 12 contact stalks 2, while the alignment guide 28 maintains stalks 2 in a largely upright, vertical orientation as the stalks 2 enter the row unit 11. This alignment guide 28 may be mounted above or below the corn head 7 stripper plates.

II. Single Member (Wand) Sensor Systems

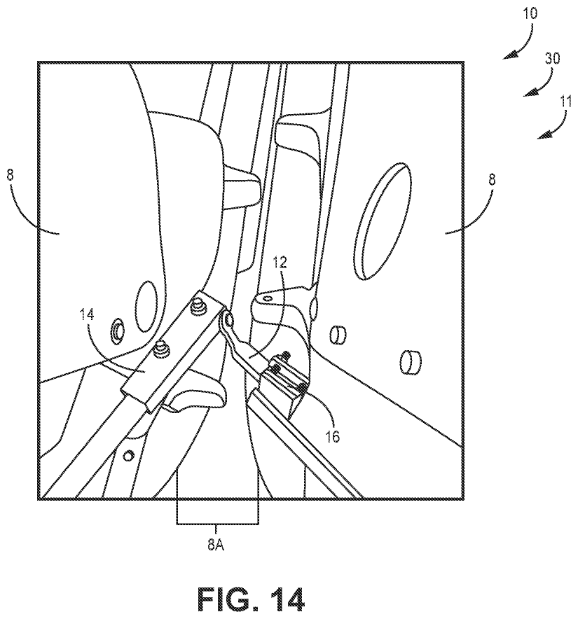

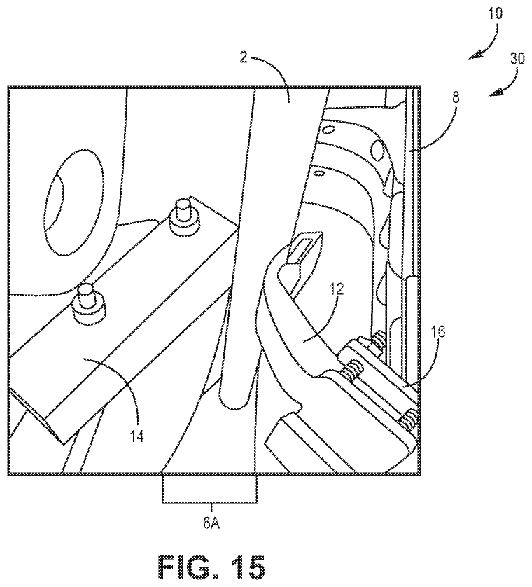

FIGS. 14-15 depict various single wand sensors 30, various of these implementations have one resilient wand 12 that spans the entire stripper plate gap 8A. The distal end or tip of the wand 12 may rest against a fence 14 on the other side of the stripper plate gap 8A from the member attachment 16 when in the neutral position. In use, each time a stalk 2 passes through the single wand sensor 30, the wand 12 flexes and is displaced from the fence 14 in proportion to the stalk 2 size. In these implementations, the resilient properties of the wand 12, as noted above, rapidly urge the return of, or snap, the wand 12 back to its neutral or resting position or substantially so after each stalk 2 passage.

In certain implementations, the system 10 includes a stalk counting algorithm that counts stalks 2 according to wand 12 flex readings. In further implementations, the system 10 includes a stalk sizing algorithm to determine stalk 2 size according to wand 12 flex readings. In further implementations, the stalk sizing algorithm may segregate stalks 2 into two or more categories including for example productive stalks and late emerged stalks (thin unproductive stalks). Methods, systems, and devices for measuring wand 12 flex/displacement will be discussed further below.

In certain implementations, the wand 12 spans across the stripper plate gap 8A to the fence 14 to ensure thin stalks 2 riding along the fence 14 will contact and therefore flex the wand 12 and produce a measurable displacement from the fence 14. A gap between the wand 12 end and fence 14 may allow thin stalks 2 to pass without flexing the wand 12, resulting in an unmeasured stalk 2.

In various implementations, the fence 14 is a rigid fence 14. In various alternative implementations, the fence 14 is a moveable/flexible fence 14. Examples of moveable fences 14 are spring biased rigid fences 14 or resilient fences 14, various other implementations would be recognized by those of skill in the art.

In some implementations, the fence 14 will be flush with the edge of the stripper plate 8. For example, a rigid fence 14 protruding past the stripper plate 8 edge into the stripper plate gap 8A may impede crop flow through the corn head and this may cause stalks 2 to bunch or plug the row unit 11. A rigid fence set 14 back from the stripper plate 8 edge could result in incorrectly measured stalk 2 sizes due to stalks 2 riding against the stripper plate 8 edge instead of the fence 14.

As would be appreciated, many corn heads 7 have laterally adjustable stripper plates 8 and in certain instances only one of the two stripper plates 8 is adjustable. In implementations where only one stripper plate 8 is adjustable, the fence 14 may be mounted on the nonadjustable stripper plate 8 side to ensure the fence 14 remains flush with the stripper plate 8 edge. Moveable fences 14 may be used to keep the fence flush 14 in configurations where both stripper plates 8 are adjustable.

Various implementations of single wand sensors 30 are effective at counting harvested and missing stalks 2 and detecting a plugged row condition. In certain implementations, as discussed herein single wand sensors 30 may be used to measure stalk 2 size include the perimeter of a stalk 2.

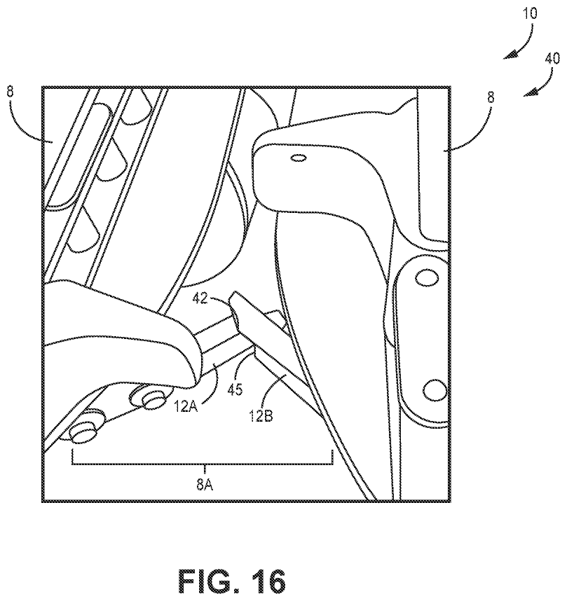

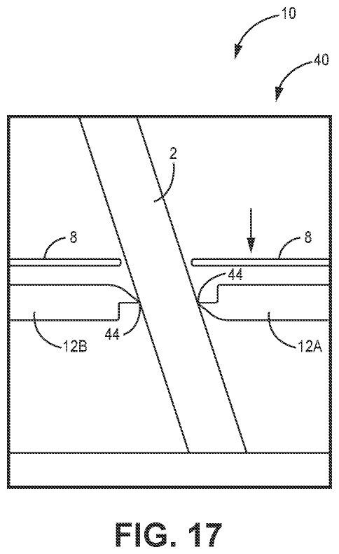

Turning now to FIGS. 16-17 that depict a dual member or dual wand sensor 40. In an exemplary implementation, the dual member sensor 40 comprises two resilient wands 12A, 12B; one wand 12A protruding across the stripper plate gap 8A from one stripper plate 8, and a second wand 12B protruding across the stripper plate gap 8A from the other stripper plate 8. In various implementations, both wands 12A, 12B span the entire stripper plate gap 8A such that both wands 12A, 12B will flex or be displaced each time a stalk 2 passes through the dual wand sensor 40. Such a configuration may be able to accurately measure thin stalks 2 riding along either stripper plate 8.

In various implementations, and as discusses above, the resilient properties of the wands 12A, 12B may rapidly snap the wands 12A, 12B back to a neutral or resting position, or substantially so, after each stalk 2 passage through the dual member sensor 40. In certain implementations, a stalk counting algorithm counts stalks 2 according to wand flex readings of both wands 12A, 12B. In further implementations, the system 10 includes a stalk sizing algorithm to determine stalk 2 size according to wand flex readings. In still further implementations, the stalk sizing algorithm may segregate stalks 2 into two or more categories including, for example, productive stalks and late emerged stalks (thin unproductive stalks). As noted above various methods, systems, and devices for measuring wand 12A, 12B flex and/or displacement will be discussed further below.

In some implementations, both wands 12A, 12B are in the same fore/aft position so that they will overlap when in their neutral or resting position. That is, the wands 12A, 12B are substantially opposite each other on the row unit 11. The various of these implementations, each wand 12A, 12B may include a notch 42 that serves as a return cradle stop for the other wand 12A, 12B. The notch 42 may act to dampen the returning wand 12A, 12B and thereby minimize sensor ringing.

In certain implementations, the stalk 2 contacting points of each wand 12A, 12B are on the same or substantially the same horizontal plane across the stalk 2. As would be understood stalks 2 may enter the row unit 11 at a non-vertical angle, such as due to steering errors which may cause the stripper plate gap 8A to misalign with the incoming stalk 2 row. By contacting stalks 2 on the same horizontal plane the dual wand sensor 40 is able to accurately measure stalks 2 that enter the stripper plate gap 8A at a non-vertical angle.

FIG. 17 shows a stalk 2 passing through at a non-vertical angle. In this specific implementation, the stalk 2 contact point for each wand 12A, 12B is on the same horizontal plane across the stalk 2. In various implementations, each wand 12A, 12B has a notch or opening 44 defined at the contact point for the stalk 2. FIG. 17 depicts one of many various wand 12A, 12B shapes with a knife edge 44 contact point, other shapes and configurations would be known and appreciated by those of skill in the art.

In various implementations, the senor system 10, including both the single member sensor 30 and dual member sensor 40, may be mounted under the stripper plates 8 as shown in FIG. 16. Alternate implementations allow for the mounting of the sensor system 10 above the stripper plates 8, as would be readily appreciated by those of skill in the art.

Further, sensor system 10 mounted under the stripper plates 8 may be positioned close to the stripper plates 8 and therefore be able to accurately measure stalks entering the sensor at non-vertical angles. As would be appreciated, sensing close to the stripper plates 8 may be advantageous because the stripper plates 8 may act similar to the guide 28 discussed above and restrict the stalk 2 angle as stalks 2 enter the row unit 11. That is, angled stalks 2 entering stripper plates 8 tend to be somewhat “stood up” or urged into a more vertical orientation at the point of stripper plate 8 contact.

III. Detection and Measurement

The various implementations of sensors and sensing methodologies detailed below may be implemented for both single wand sensors 30 and the dual wand sensors 40. In certain implementations, the stalk sensor system 10 utilize magnets 52 embedded in the wand(s) 12A, 12B and magnetic field strength sensors 54 to detect and measure stalks 2. In these implementations, measuring magnetic field is possible because magnetic fields can penetrate through (are not affected by) nonferrous materials such as leaves, corn stalks 2, dust, and the like present during harvest operations. Further, magnetic fields can also penetrate nonferrous metals, which allows for the use of various durable nonferrous metals in wands 12 and other elements of the system 10.

As would be appreciated, the corn harvester header 7 is a very harsh environment in which to implement a corn stalk sensing system 10. The use of magnets 52 and magnetic field strength sensors 54 allows for the creation of a durable sensor apparatuses 50 that can survive this harsh environment. In certain implementations, the only moving parts of the sensor apparatus 50 is the resilient wand 12 or wands 12A, 12B. By reducing the number of moving components the durability and longevity of the sensor system 10 can be extended.

In various implementations, the resilient wand 12 or wands 12A, 12B completely envelope the magnet 52 that creates the magnetic field to be sensed. That is, the magnet 52 may be embedded within the resilient member 12 or members 12A, 12B. Additionally, magnetic field strength sensors 54 and magnets 52 can be relatively small and low cost, allowing for the creation of a sensor apparatus 50 that can be easily integrated into a corn harvest head 7, as either part of an entirely new corn head 7 or as part of a retrofit of an existing corn head 7.

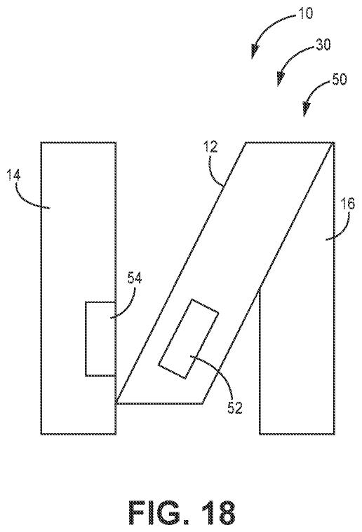

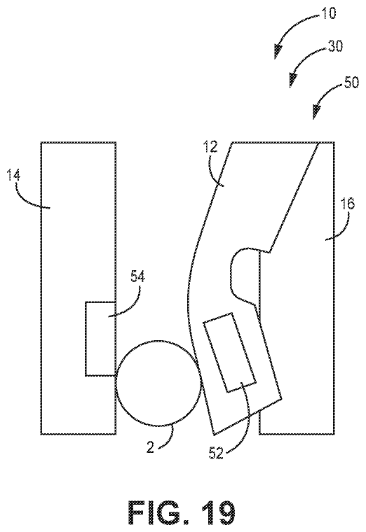

Single wand sensors 30. Turning to FIGS. 18 and 19, in implementations using a single resilient member 12, a magnet 52 may be embedded in or attached to the wand 12 such that one of the poles of the magnet 52 is oriented outward to the contact surface of the wand 12. In these implementations, a magnetic distance sensor 54 is placed in a fixed element such as a fence 14 opposite the wand 12 and magnet 52. As discussed above, the fence 14 may be oriented such that the wand 12 contacts the fence 14 when there is no corn stalk 2 in the sensor apparatus 50.

In certain implementations, a magnetic distance sensor 54 measures the strength of the magnetic field created by the magnet 52. Based on the strength of the magnetic field measured and considering the magnetic strength and orientation of the magnet 52, a distance can be calculated from the sensor 54 to the magnet 52. This, in turn, allows the amount deflection of the resilient wand 12 in response to a corn stalk 2 passing through the sensor apparatus 50. In certain implementations, the sensor 54 measures the decrease in the magnetic field strength as the deflection of the wand 12 increases, increasing distance between the magnet 52 and the magnetic sensor 54.

In an alternate implementation, the permanent magnet 52 may be embedded in the fence 14 and the magnetic sensor 54 located in or on the wand 12. The methodology of measuring the distance between the magnet 52 and the sensor 54 remains the same where increasing deflection of the wand 12 results in decreasing magnetic field strength.

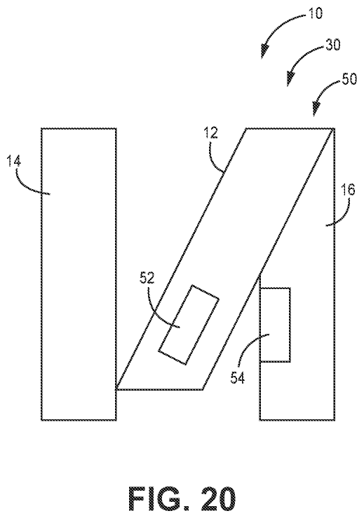

In another implementation, shown in FIG. 20, the system 10 includes a single resilient wand 12 with a permanent magnet 52 embedded in or otherwise attached to the wand 12 such that at least one of the poles of the magnet 52 is oriented outward to the surface of the wand 12. Similar to previously discussed implementations, a fence 14, or other fixed element, is located opposite to the wand 12 such that the wand 12 contacts the fence 14 when there is not a plant stalk 2 in the apparatus 50.

In these and other implementations, a magnetic distance sensor 54 is placed in a fixed housing 16 adjacent to the wand 12 and magnet 52. That is the magnetic distance sensor 54 is located on the same side of the row unit 11 that the wand 12 is attached to. The fixed housing 16 for the sensor 54 may also be the attachment element 16 for mounting the wand 12, described above, although other fixed housings 16 are possible and would be recognized by those of skill in the art.

As stated above, the magnetic distance sensor 54 measures the strength of the magnetic field generated by the magnet 52. Based on the strength of the magnetic field measured and considering the magnetic strength and orientation of the permanent magnet 52, a distance can be calculated from the sensor 54 to the magnet 52. In these implementations, the sensor 54 measures increased magnetic field strength as the deflection of the wand 12 increases and distance between the magnet 52 and magnetic sensor decreases.

In a further implementation, the permanent magnet 52 is embedded into the fixed element 16 on the same side of the row unit as the wand 12 and the magnetic sensor 54 is embedded in the wand 12. The methodology of measuring the distance remains the same where increasing deflection of the wand 12 results in increasing magnetic field.

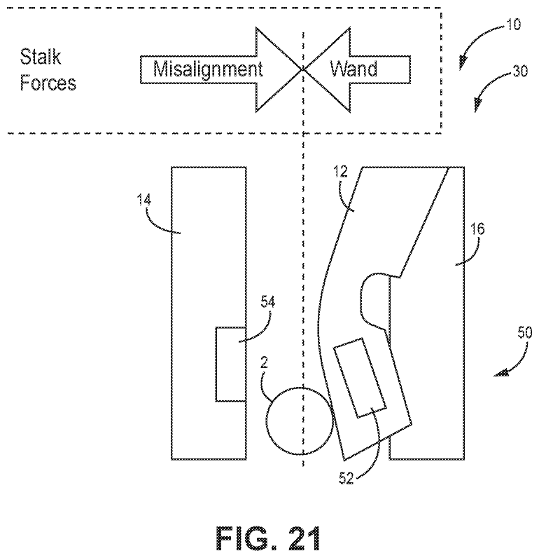

FIG. 21 depicts an exemplary situation in which an entering stalk 2 is misaligned with the sensor apparatus 50. Misalignment can occur when the center of the row harvesting unit 11, where the corn stalks 2 are fed in, is not directly above the point at which the corn stalks 2 attach to the ground. In these situations, as the stalk 2 is fed into the row unit 11 misaligned stalks 2 can be pushed up against one side of the stripper plates 8. The force created by stalk 2 misalignment may overcome the restoring force of the wand 12 that pushes the stalk 2 against the opposing fixed element 14 or fence 14 as it is passing through the sensor apparatus 50. This type of misalignment may causes the wand 12 to be deflected to a greater extent than the size of the stalk 2. In these implementations, the sensor system 10 may measures the stalk 2 as larger than it actually is, as is illustrated in FIG. 21.

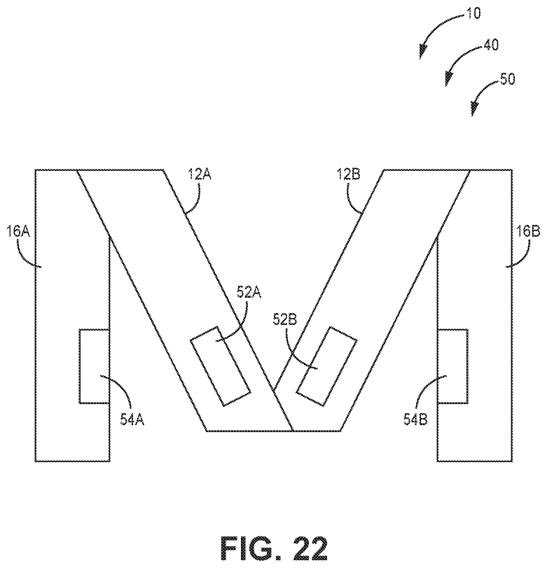

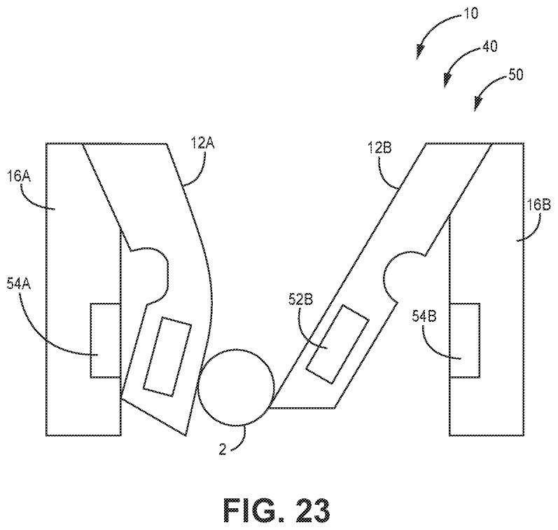

Dual wand sensor systems 40. In various implementations, depicted in FIGS. 22 and 23, the dual wand sensor 40 includes two resilient wands 12A, 12B and permanent magnets 52A, 52B embedded in or attached to each wand 12A, 12B such that one of the poles of the magnet 52A, 52B is oriented outward to the surface of the wand 12A, 12B. In various implementations, magnetic distance sensors 54A, 54B are placed in each of the fixed elements 16A, 16B adjacent to the wands 12A, 12B and magnets 52A, 52B. The fixed elements 16A, 16B may also be used as mounting point for the wands 12A, 12B. As would be appreciated the magnetic sensors 54A, 54B may be located in the wands 12A, 12B while the magnets 52A, 52B are located in the fixed elements 16A, 16B, corresponding changes to the operation of the sensor apparatus 50 would be appreciated.

In these and other implementations, the magnetic sensors 54A, 54B on both sides of the sensor apparatus 50 measure the strength of the magnetic field produced by the corresponding magnet 52A, 52B in the corresponding wand 12A, 12B. Based on the strength of the magnetic field measured and considering the magnetic strength and orientation of the magnet 52A, 52B, a distance can be calculated from the sensor 54A, 54B to the magnet 52A, 52B. In similar fashion to that described in relation to the single wand sensor 30 implementations discussed herein.

In various dual wand systems 40, the deflection distances measured by each sensor 54A, 54B are combined to produce a total deflection distance produced by a corn stalk 2 passing through the sensor apparatus 50. This total deflection distance may be correlated to the size of the stalk 2 and/or the perimeter of the stalk 2.

In these implementations, the wands 12A, 12B may be mounted at the same level and contact each other at the center of the measurement area when in a neutral or resting position. This center point or neutral position is considered the zero distance. In certain situations, when only one wand 12A, 12B is deflected, the other wand 12A, 12B may extend beyond its zero distance, increasing the detected distance from the magnet 52A, 52B the sensor 54A, 54B on that side. That is, in these implementations, the system 10 allows for deflection measurement beyond the neutral position.

In various implementations, the wands 12A, 12B are sized so that the minimum-detectable corn stalk 2 size will produce wand-to-wand deflection over the entire measurement range which typically corresponds to the gap 8A between the stripper plates 8.

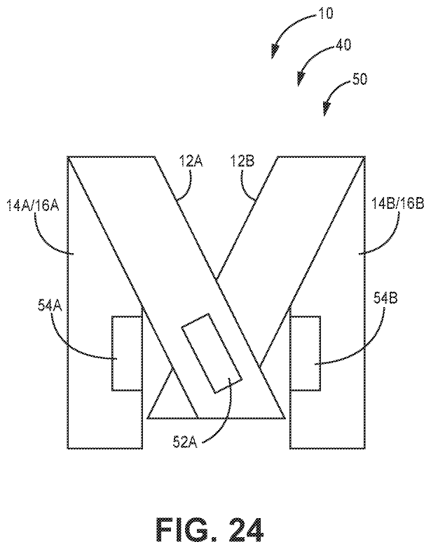

An alternative dual wand sensor 40 implementation, includes the wands 12A, 12B and corresponding sensors 54A, 54B at different levels, as shown in FIG. 24. These implementations, may include two single wand units 12A, 12B stacked vertically. In these and other implementations, magnet 52A, 52B orientation, multi-axis sensors 54A, 54B, and signal processing algorithms may be used to reduce the effect of cross-talk between the magnets 52A, 52 and the sensors 54A, 54B and thereby improve performance.

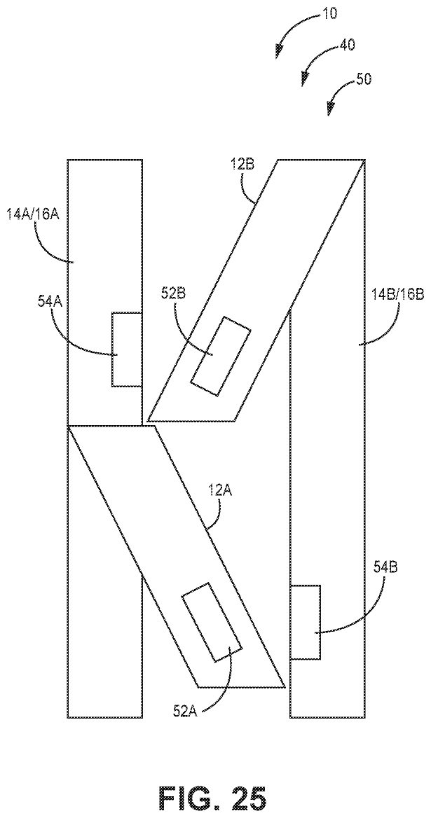

Another dual wand sensor 40 implementation includes wands 12A, 12B and sensors 54A, 54B arranged sequentially as shown in FIG. 25. In these implementations, the wands 12A, 12B are arranged one after the other, such that a stalk 2 will contact a first wand 12B then the second wand 12A as the stalk 2 travels through the sensor apparatus 50. These implementations may more accurately measure stalks 2 that pass through the sensor apparatus 50 along the sides of the fences 14A, 14B and/or fixed elements 16A/16B. In these implementations, the magnets 52A, 52B are further separated such that interference between the magnets 52A, 52B can be reduced, minimized or eliminated. These implementations may further include a stalk differentiation algorithm to differentiate between different stalks 2 being measured/contacting the wands 12A, 12B at or near the same time.

Electromagnet. For any of the implementations, an electromagnet 52 could be used in place of other magnet 52 type to create the magnetic field to be measured by the sensor 54. The use of an electromagnet 52 allows a varying magnetic field to be created. In various implementations, varying the magnetic field may be used to improve performance of the sensor apparatus 50, as would be readily appreciated.

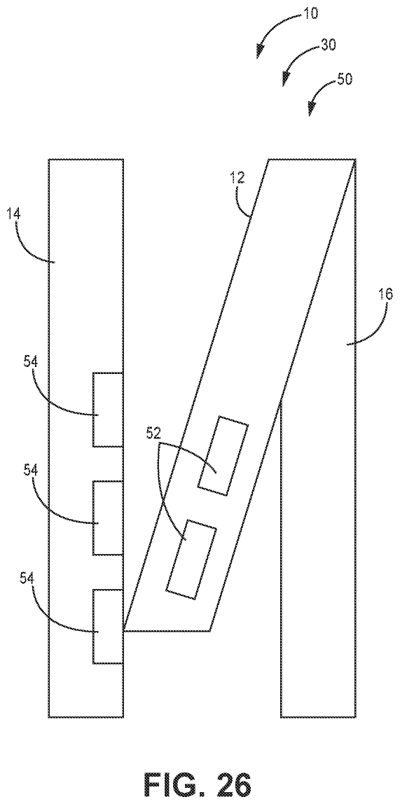

Multiple sensors and/or magnets. In any of the above sensor implementations, additional implementations are conceived that have multiple magnetic sensors 54 and or magnets 52 in a single wand 12, fence 14 and/or fixed element 16. An exemplary implementation using multiple sensors 54 and magnets 52 is shown in FIG. 26. As would be understood, the magnetic field of the magnet 52 embedded in the resilient wand 12 can vary greatly depending on the orientation of the magnet 52. In these implementations, because the wand 12 itself is flexible and bends in response to stalks 2 and other material passing through the sensor apparatus 50, the orientation of the magnet 52 can vary in relation to the magnetic sensor 54. The use of multiple magnetic sensors 54—optionally in different orientations—may allow the detection of the variations in magnetic field produced by the magnet 52 and its orientation thus allowing the sensor signal processor to compensate for the variation in magnetic field.

Further, FIG. 26 also depicts the use of multiple magnets 52. The movement of the resilient wand 12 and its embedded magnet 52 may not be optimal for sensing the magnetic field and measuring the corresponding distance. Multiple permanent magnets 52 may be used to increase the strength and/or breadth of the magnetic field for improving sensor performance and distance measurement.

Use of both multiple magnets 52 and multiple sensors 54 at the same time is not required. A system 10 and apparatus 50 may have single or multiple magnets 52 and/or single or multiple magnetic sensors 54 in any combination or configuration, as would be readily appreciated.

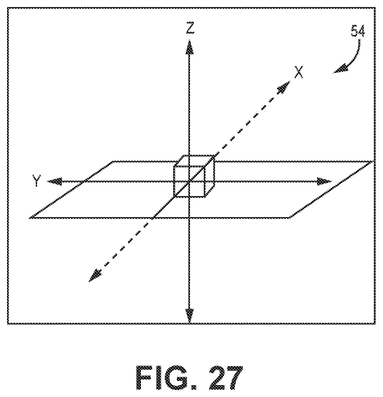

Mu/ti-axis magnetic sensors. Distance magnetic sensors 54 (i.e. field strength measurement sensors) may detect up to three (3) axes of measurement where the measurement axes are typically orthogonal, as shown in FIG. 27. In various implementations, the magnetic sensors 54 are multi-axis sensors 54. The use of sensors 54 with multiple axes in measuring the magnetic field from the embedded magnet 52 can be used to detect the orientation of the magnet 52 in addition to the strength of the magnetic field. The additional data regarding the orientation of the magnet may be used, in certain implementations, to improve the distance measurement from the magnet 52 to the sensor 54.

FIG. 27 shows the axis orientation for 3-axis magnetic sensor 54, according to one implementation. For the 3-axis sensor 54 shown, a magnet 52 within detection distance of the sensor 54 will produce detection values for the X, Y, and Z axes that depend on the distance and orientation of the magnet 52. For the stalk sensor 54, the individual measurements from each axis are processed to produce a distance and orientation of the magnet 52 embedded in the wand 12 with respect to the sensor 54. As an example, if there is movement of the wand 12 in any direction, a multiple axis sensor 54 can detect that movement and be able to compensate for such movement in determining the deflection distance, as would be readily appreciated.

Magnet orientation. In various implementations, the magnets 52 are disk magnets 52 that are embedded in the wand 12 with the poles of the magnet 52 perpendicular to the front and back (vertical) faces of the wand 12. In certain implementations the orientation of the magnet 52 and its magnetic field within the wand 12 may be adjustable. Likewise, the orientation of the distance magnetic sensors 54 may be adjusted to optimize the sensors 54 ability to detect the magnetic field and provide a consistent distance measurement over the deflection range of the wand(s) 12.

Non-resilient wands. In various implementations, the wands 12 are not made of resilient material but rather are substantially rigid. In various implementations, a magnet 52 or magnetic sensor 54 can be embedded in a non-resilient wand 12. The magnet 52 or sensor 54 according to certain implementations comprises non-ferrous material and is configured to be used to count and measure stalk size by detecting wand 12 displacement as described herein. In these and other implementation, an element 58 at the wand attachment point, or elsewhere along the wand 12 would apply a restoring force to return the wand 12 to a zero (or neutral) point when there is no corn stalk 2 passing through the apparatus 50.

Non-contact angle sensor. Various further implementations may implement a non-contact inductive position sensor to measure the deflection of the wand 12. As would be appreciated, a non-contact inductive position sensor uses transmit and receive coils to measure the position of a conductive target that is either sliding or rotating. In these, implementations, current is modulated through the transmit coils to create an electromagnetic field that is influenced by the conducting target at close proximity. The measurement of the received electromagnetic field in the receive coils can be used to determine the position of the target based on the design of the receive coils. In various implementations, the non-contact angle sensor can be incorporated into the mounting (i.e. hinge point) of the wand 12. As the wand 12 is deflected by the passing corn stalk 2, the wand 12 moves the conductive target of the sensor. The measured angle of deflection would use a conversion function to produce a wand 12 deflection distance which then correlates to stalk 2 size and/or stalk 2 perimeter.

Inductance sensor. As would be understood, an inductive sensor is a sensor technology usually used to measure the distance (or proximity) of metal targets at close range. In various implementations, the system 10 and sensor apparatus 50 may use an inductive distance sensor and a metal target in place of or in addition to the various magnetic sensors 54 and magnets 52, respectively, as would be appreciated. As would be understood by those of skill in the art, an inductive sensor works by oscillating a current through a coil of wire called the sensing coil. This oscillating current produces an electromagnetic field near the surface of the sensor. When the metal target enters the electromagnetic field, eddy currents are produced which reduce the amplitude of the electromagnetic field. In these implementations, the system 10 may be calibrated to allow the sensed amplitude of the generated electromagnetic field to correlate to the distance from the metal target, which gives a measured deflection distance of the wand 12.

Capacitive sensor. As would be understood, a capacitive sensor is a sensor technology for measuring distance or proximity at close range. In these implementations, both metal and non-metal targets can be used. In various implementations, the sensor apparatus may include a capacitive distance sensor and a metal target, in place of or in addition to the magnetic sensor 54 and magnet 52, respectively. Those of skill in the art would readily appreciate that a capacitive sensor creates a varying electric field that is altered by the position of the embedded target in the wand 12. The change in electric field corresponds to a change in the current needed to drive the varying voltage to the sensor. In these implementations, the system 10 can be calibrated to allow the sensor to correlate the measured electrical field (such as the current) to the distance from the target, thus producing a measurement of the deflection distance of the wand 12.

Optical sensor. In various implementations, the system 10 and sensor apparatus 50 may include an optical distance sensor for detecting the deflection distance of the wand 12. In these implementations, the system 10 may use triangulation or time-of-flight to measure distance. In optical distance sensor implementations, the optical element is placed in or behind the fixed element near the wand 12 (shown for example in FIG. 20). The sensor transmits a beam of light or laser which reflects off the wand 12 and returns to a receiver element, which may be adjacent to the transmitter. A reflective material may be placed on the wand 12 to aid in reflection of the transmitted light back toward the sensor.

Flex sensor (flexible resistance. As would be readily understood, a flex sensor is a flexible device whose resistance increases as the device is bent or flexed. Various implementations, of the wand 12 or wands 12A, 12B of the stalk sensor apparatus 50 are made, at least in part, of flexible material that bends or flexes as corn stalks 2 pass through the apparatus 50. In one implementation of the apparatus 50, a flex sensor is integrated into the flexible wand 12. In these implementations, the resistance of the flex sensor is used to measure the deflection of the wand 12, corresponding to the size of the stalk 2 passing through the apparatus 50. The flex sensor could also be added to other implementations to aid in the corn stalk 2 detection and measurement process.

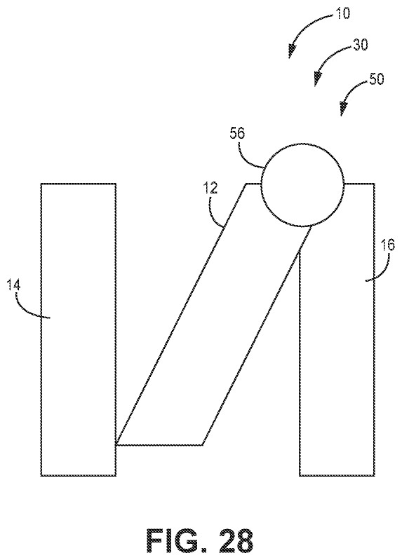

Load cell FIG. 28 shows a torsion load cell 56, according to one implementation. That is, FIG. 28 illustrates a single wand sensor system 30 where a torsion load cell 56 is located at the wand 12 attachment point. In these implementations, the load cell 56 measures the force applied to the wand 12 when it is displaced from the stop or its neutral position. The displacement distance of the wand 12 will be proportional to the force applied to the load cell 56. Signal processing of the measured force of the load cell 56 will produce a calculated wand 12 displacement which will be used to detect and measure corn stalks 2. In addition to the stand-alone implementation described here, a load cell 56 may be added to other implementations as an additional sensor for the purpose of aiding in the detection and/or displacement measurement performance of the sensor apparatus 50. Various modifications may be made to incorporate a load cell configured into a dual wand sensor 40.

Ultrasonic distance sensor. In an alternative implementation—similar to that shown in FIG. 20—the sensor 54 may be a short-range, high-speed ultrasonic sensor. In various so these implementations, an ultrasonic sensor is positioned so that it transmits high frequency sound waves that are reflected off the wand 12, or vice versa. The flight time of the sound waves from transmission to receipt may correspond to the deflection distance of the wand 12. As would be understood, reflection ultrasonic sensors usually have a minimum dead band distance required, as such the sensor would have to be positioned away from the wand 12 so that the minimum dead band is met when the wand 12 is at full deflection.

In various alternative implementations, the transmission point and receiver of an ultrasonic sensor may be separated. In these implementations, the transmitter may be placed in the wand 12 and the receiver may be placed in the attachment element 16, or vice versa. Such a sensor may reduce or eliminate the required dead band distance.

Various combinations and configurations of multiple sensor 54 and sensor target 52 types are contemplated. That is, the system 10 and sensor apparatus 50 may combine for than one type of sensor 54 and sensor target 52. Further, the system 10 and sensor apparatus 50 may combine multiple of the same type of sensor 54 and/or sensor target 52 in a single embodiment.

Signal processing. In various implementations, signal processing to measure wand 12 deflection and produce wand 12 displacement measurements may include sampling the magnetic sensor 54, or other sensor, at a high rate relative to the speed and frequency of the corn stalks 2 passing through the sensor apparatus 50. In one specific example, the sample rate may be about 1000 Hz, although other sample rates may be used as would be understood, such as between about 200 HZ and about 2000 Hz or more.

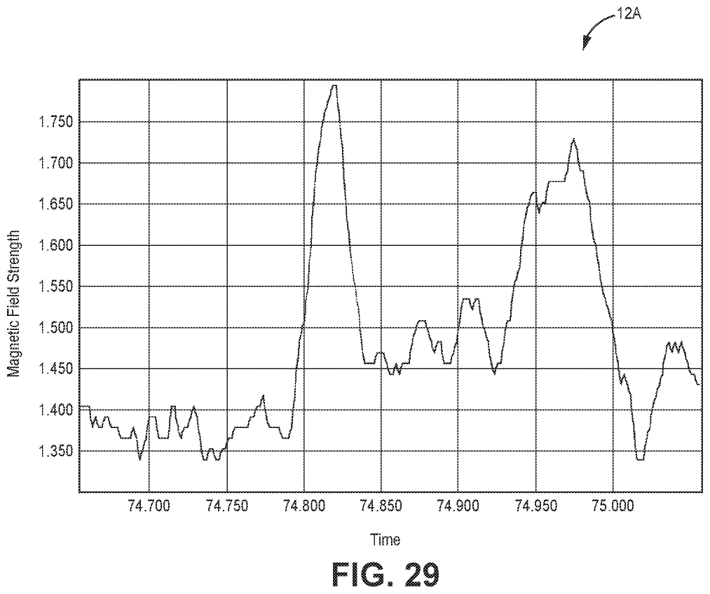

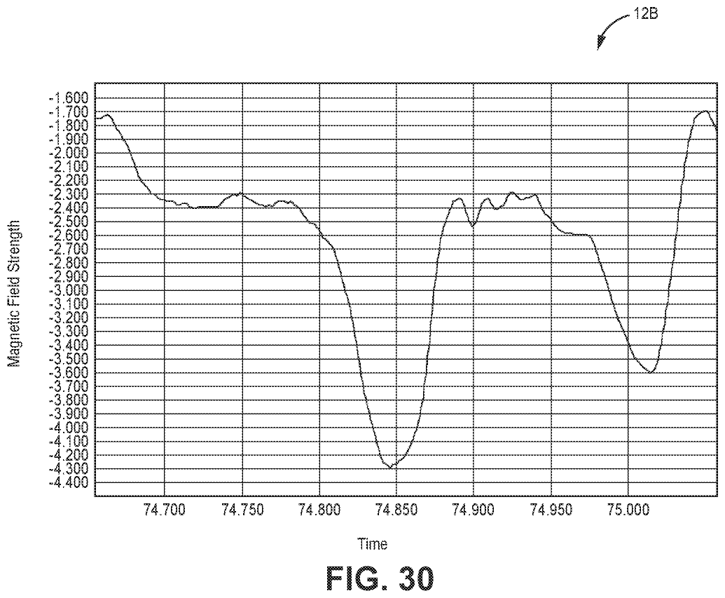

FIGS. 29-31 depict exemplary sensor 54 signals corresponding to a 400 millisecond sample period in which two corn stalks 2 passed through a sensor apparatus 50—specifically the dual wand sensor 40 shown in FIG. 16. FIG. 29 shows the sampled magnetic field strength for a first wand 12A and FIG. 30 shows the sampled magnetic field strength for the right wand 12B. In this implementation, the deflection signals were filtered over 10 samples to reduce sensor 54 noise and produce a smoother signal.

In certain implementations, a calibration procedure (described below) may optionally be performed for each wand 12A, 12B to calculate a formula that produces a measured displacement distance based on measured magnetic field strength.

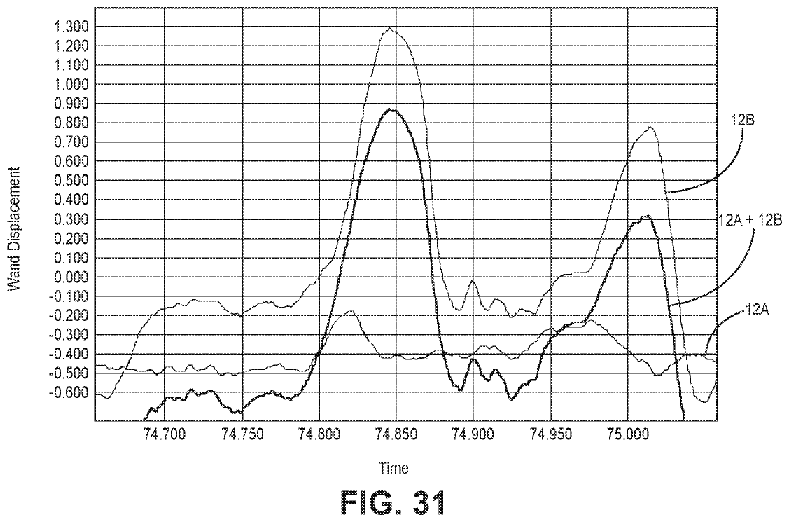

FIG. 31 shows the resulting displacement distance for the left wand 12A and right wand 12B (measured in inches), as well as the combined displacement for both wands 12A+12B that represents the displacement produced by the corn stalk 2 passing through the sensor apparatus 50.

In various implementations, the system 10 may be calibrated by deflecting each wand 12A, 12B using a set of boards, or other devices, of known thickness through the wand 12 deflection range. At each known deflection (or thickness), the measured value of the magnetic field strength is recorded. The recorded values for magnetic field strength may then be graphed against their corresponding deflection and a deflection equation determined for each wand 12A, 12B. In implementations having a double wand sensor 40, the measured deflection distances from each wand 12A, 12B are added together to produce the total deflection, which corresponds to the displacement produced by the corn stalk 2 passing through the sensor assembly 50.

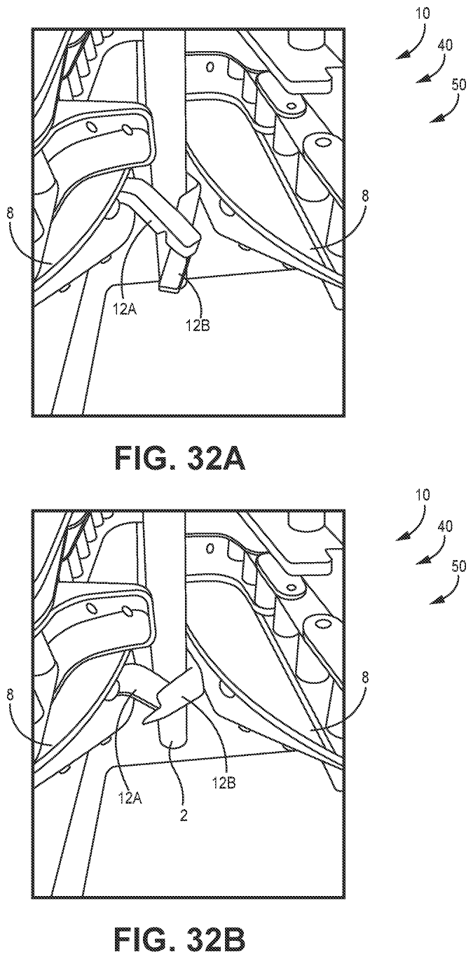

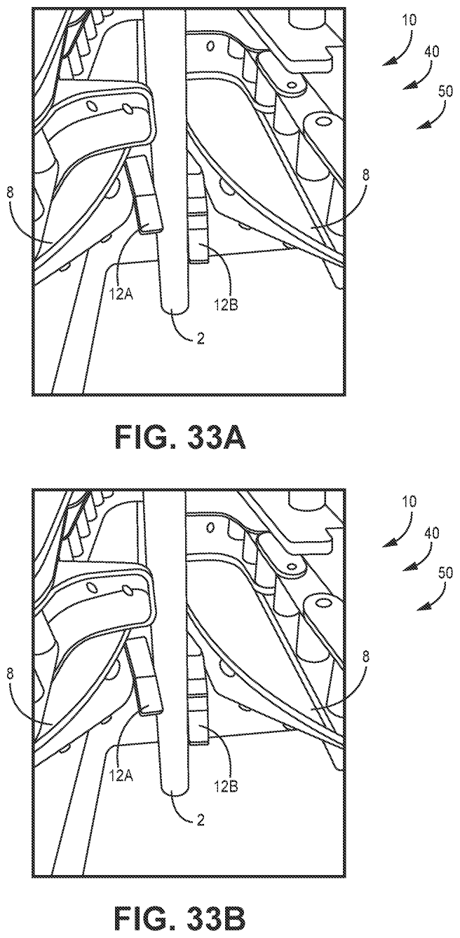

Reverse operation. FIGS. 32-33 depict implementations of the system 10 directed to reverse operation, such as to clear the corn head 7 in the case of a plug or other reason, as would be appreciated.

In various implementations, under normal operating conditions the wands 12A, 12B form a “V” shape that is open to the flow of stalks 2 as the combine 6 moves forward through the field during harvest operations. Standing stalks 2 pass through the counter wands 12A, 12B and into the combine 6 head 7 mechanism where the ear is stripped off by the stalk rolls. As would be appreciated, occasionally the row unit 11 on the corn head 7 may plug with stalks 2, weeds, or other material. When this happens the combine 6 operator can reverse the operating direction of the corn head 7 to push the plugged material forward out of the corn head 7 to clear the blockage. In various implementations, the stalk counter wands 12, 12A, 12B are designed to allow this type of reverse operation to happen without impeding the reverse direction flow and then reset to normal operation without any direct input or effort by the operator or others.

In various implementations, the resilient wands 12, 12A, 12B are constructed and arranged so that they can buckle over to allow the stalks to flow through a reverse “V” shape as shown in FIGS. 32A-B and 33A-B. In various implementations, the wands 12, 12A, 12B are then free to disengage with either each other or with a fence 14 and the crop is free to flow through the wand 12 or wander 12A, 12B.

After the crop has cleared the wand 12 or wands 12A, 12B, the wand 12 or wander 12A, 12B flex towards their neutral or resting position. New crop subsequently entering the head 7 will return the wand 12 or wands 12A, 12B to their normal operating position.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Although the disclosure has been described with reference to implementations, persons skilled in the art will recognize that changes may be made in form and detail without departing from the spirit and scope of the disclosed apparatus, systems and methods.

What is claimed is:

1. A stalk measuring system comprising:
(a) a row unit;
(b) at least one resilient sensing member engaged with the row unit;
(c) a distance sensor within a housing on the row unit; and
(d) a sensor target on the at least one resilient sensing member;
wherein the distance sensor is constructed and arrange to measure the deflection of the sensor target as the resilient sensing member flexes in response to harvest operations.

2. The system of claim 1, wherein the amount of deflection corresponds to stalk perimeter.

3. The system of claim 1, wherein deflection corresponds to a stalk count.

4. The system of claim 1, wherein the at least one resilient sensing member is comprised of at least one of elastic, viscoelastic, nitrile, ethylene propylene diene terpolymer (EPCM), neoprene, natural rubber, silicone, fluro-elastomer, and spring steel.

5. The system of claim 1, wherein the at least one resilient member is comprised of a composite material, wherein the composite material comprises at least one of cellulose, aramid, nylon, glass, and carbon fiber.

6. The system of claim 1, wherein the at least one resilient member further comprises a contact surface and an additional material disposed on the contact surface.

7. The system of claim 6, wherein the additional material is at least one of acetal, resin, nylon resin, thermoplastic polyester elastomer, liquid crystal polymer resin, and metal.

8. A stalk sensor comprising:
(a) a first wand operationally engaged with a first side of a row unit at an attachment point;
(b) a first distance sensor disposed on the row unit in proximity to the first wand; and
(c) a first sensor target embedded within the first wand,
wherein the stalk sensor is constructed and arranged to measure the deflection of the first wand in response to passage of a stalk through the stalk sensor, and wherein the amount of deflection corresponds to the perimeter of the stalk.

9. The stalk sensor of claim 8, wherein the first sensor target is a magnet.

10. The stalk sensor of claim 9, wherein the first distance sensor is a magnetic field sensor.

11. The stalk sensor of claim 8, further comprising a second distance sensor disposed on the row unit and a second sensor target embedded within the second wand.

12. The stalk sensor of claim 8, further comprising:
(a) a second wand operationally engaged with a second side of the row unit;
(b) a second distance sensor disposed on the row unit in proximity to the second wand; and
(c) a second sensor target disposed within the second wand,
wherein the stalk sensor is constructed and arranged to measure the amount of deflection of the first wand and the second wand in response to passage of a stalk through the stalk sensor, and wherein the cumulative amount of deflection of the first wand and the second wand corresponds to the perimeter of the stalk.

13. The stalk sensor of claim 12, wherein the first distance sensor and second distance sensor are magnetic field sensors and the first sensor target and second sensor target are magnets.

14. The stalk sensor of claim 13, wherein the first wand and second wand are arranged to span across an entirely of a stripper plate gap of the row unit.

15. A stalk sensing system comprising:
(a) a row unit;
(b) a first wand comprising a first magnet, the first wand disposed a first side of the row unit; and
(c) a second wand comprising a second magnet, the second wand disposed on a second side of the row unit,
(d) a first magnetic field sensor disposed on the first side of the row unit, the first magnetic field sensor constructed and arranged to measure a deflection distance of the first wand;
(e) a second magnetic field sensor disposed on the second side of the row unit, the second magnetic field sensor constructed and arranged to measure a deflection distance of the second wand,
wherein a sum of the deflection distance of the first wand and the deflection distance of the second wand correspond to a stalk perimeter.

16. The system of claim 15, wherein the first wand and the second wand are arranged to be substantially opposite each other on the row unit and located on the same horizontal plane.

17. The system of claim 15, wherein the first wand and the second wand are arranged to be substantially opposite each other on the row unit and located on the different horizontal planes.

18. The system of claim 15, wherein the first wand and the second wand are arranged in sequence on the row unit.

19. The system of claim 15, wherein the first wand and the second wand are arranged such that a first end of the first wand overlaps with a first end of a second wand at the center of the row unit.

20. The system of claim 15, wherein the first wand and the second wand are mounted below a set of stripper plates on the row unit.
